(19) United States
(12) Patent Application Publication
(10) Pub. No.: US 2004/0023095 A1
(43) Pub. Date: Feb. 5, 2004

(54) Production of pem fuel cells tacks

(76) Inventors: Erik Middelman, Arnhem (NL); Arthur Van Der Zuden, Wetervoort (NL)

Correspondence Address: Thomas J Pardini, Oliff & Berridge, PO Box 19928, Alexandria, VA, 22320, US

(21) Appl. No.: 10/204,131

(22) PCT Filed: Feb. 19, 2001
(86) PCT No.: PCT/NL01/00139

(30) Foreign Application Priority Data
Feb. 17, 2000 (NL) 1014405

(51) Int. Cl. H01M 8/02; B29C 31/00

(52) U.S. Cl. 429/34; 429/38; 264/259

(57) ABSTRACT

The method according to the invention is a fabrication method for cell plates that can be used in polymer electrolyte fuel cells, and in polymer electrolyte fuel cell stacks. The plates according to the invention have a conductive area of the cell and preferably a non-conducting polymer edge around this conducting area. Cell plates according to the invention can be welded to other cell plates or can be welded to MEA's.

The invention is related to a method for the production of polymer electrolyte (PEM) fuel cells, components for PEM fuel cells and PEM fuel cell stacks.

Fuel cells are known since the discovery of Sir William Grove in the 19^{th} century. Several types of fuel cells have been developed since. One of these fuel cell types is the PEM fuel cell. A PEM fuel cell comprises typically a proton conducting membrane with a catalyst-containing electrode on both sides. Such an assembly is called a MEA (membrane electrode assembly). Typically these MEA's are placed between electrically conducting plates, often called bi-polar plates to form a single fuel cell, or if more of these cells are stacked such an assembly is called a fuel cell stack. The main functions of the bi-polar plates are conduction of electrical current from one electrode to another electrode of a in series connected fuel cell, distribution of hydrogen and oxygen or an oxygen containing gas, removal of reaction water, sealing between the gas channels and the atmosphere. Known bi-polar or mono polar plates are made from metal like stainless steel, coated metal like gold-coated stainless steel, metal foam, synthetic graphite, and conductive composite material. All these materials have their specific advantages and drawbacks as publicly known from several patents and many publications in the open literature.

Application of two so-called metal separator plates is known from for example EP 0795205B1. According to this publication a MEA is clamped between metal cell plates, and a U-shaped metal seal around the edges of the plates realizes the sealing between these cell plates. The cell design according to EP 0795205B1 has the advantage that the quality of gas sealing is made independent or almost independent from the applied clamping force in the fuel cell stack. However the technology of EP 0795205B1 has some drawbacks. First there is a risk of shorts between the metal plates. Another disadvantage applying to most metal separator plates is corrosion with resulting increase of the contact resistance. According to EP 0795205B1 the proton conducting membrane is also used as sealing material between the cell plates outside the active area. This is a costly way of sealing since this function can be performed also, or even better by several low cost polymers and elastomers.

A cell plate made of metal foams is known from for example: Electrochemica Acta, Vol. 43 no. 24, pp. 3829-3840. In this publication application on Nickel and Titanium foam is described. Advantages are excellent contact between electrode and cell plate, and the good conductivity of metals in general. Main disadvantage is corrosion or passivation of the metal surfaces. This problem is for metal foams even more severe than for non-foamed metal cell plates. Coating of the metal surface with for example gold can solve this problem, but is expensive. Yet another disadvantage is the high-pressure drop of the feed gasses that have to flow trough the material. High-pressure drop causes a reduction of system efficiency and increases the costs.

Also according to Electrochemica Acta, Vol. 43 no. 24, it is possible to make cell plates by injection molding, but is recognized that the conductivity of such products is poor. The poor conductivity is caused by the low concentration of conductive fillers. Increase of filler concentration is limited by the flow properties required for injection molding.

The invention has as its objective to provide a method for the production of polymer electrolyte (PEM) fuel cells, components for PEM fuel cells and PEM fuel cell stacks wherein drawbacks of known technologies have been eliminated.

According to an embodiment of the present invention a electrical conductive compound is prepared comprising polymer, graphite powders and optionally suitable additives. The polymer is preferably a thermoplastic, more preferably a thermoplastic material selected from the group of poly olefins or the group of fluorinated polymers. This compound is converted to a plate or sheet like intermediate product. This intermediate product is cut to the desired size, a so-called preform, and placed in a suitable heating apparatus like an air circulation oven, a radiation oven or a contact-heating tool. In the heating apparatus the preform is heated to a temperature at which the polymer melts, or passes its Tg in case of an amorphous polymer. Subsequently the heated perform is placed in a mold, and this mold is closed, forming a molded part. The mold contains the negative of the cell plate or part of the cell plate like the flow field, according to the invention. The temperature of the mold is preferably below the melting point (Tm) or the glass transition temperature (Tg) of the polymer. The molded part is removed from the mold after consolidation. In a subsequent process the cell plate or part of the cell plate is inserted in the mold of a injection molding machine. The mold is closed, and the inserted part is surrounded or partly surrounded by a polymer melt. After cooling the product is released from the mold. According to the process described above a cell plate, a half-cell or a bi-polar plate is produced comprising an good conducting area, and a poor conducting or non conducting area, the conducting area is positioned at the active area of the fuel cell to be produced. Preferably the conducting area is located in th area where conduction is required, and not outside this area.

According to another embodiment of the invention it is possible to insert the preheated perform directly in the opened injection mold. The mold is closed, the preform is formed and the polymer melt is injected subsequently. The part consisting of a good conducting area and a poor or non-conducting area are, after sufficient cooling, removed from the mold.

In yet another embodiment of the invention the electric conductive preform is inserted in the mold without pre heating to a temperature above the melting point or a temperature above the Tg of the polymer. In the mold a heating tool like an ultra sonic heating device, is integrated. This heating tool heats up the preform to molding temperature, and the plate is formed. After or during forming of the inserted preform the polymer melt is injected in the mold and surrounds, partly surrounds the conductive area.

In another embodiment of the invention a voltage potential is applied between the upper and lower half of the mold, the mold preferably being an injection mold. The electric conductive preform is inserted in the mold without pre heating to a temperature above the melting point or a temperature above the Tg of the polymer. By closing the mold the distance between the upper half and the lower half decreases until both mold halves contact the preform. A current starts to flow trough the preform, and heats it up to a temperature above the melting temperature or a temperature above the Tg of the polymer. After sufficient heating of the preform the current is switched off, the mold is closed and the polymer melt is injected in the mold and surrounds or partly surrounds the conductive area.

In another embodiment of the invention the preform is placed in a heating tool. This heating tool heats up the preform to molding temperature. The heated preform is placed between two mold halves having a temperature below the meting point or the Tg of the polymer in the preform. The press tool or mold is closed, and the product formed. The product is preferably the electrical conductive flow field. In a separate injection molding process the non-conducting part of the flow field is produced. The shape of this injection-molded part is such that the conducting flow field fits in. In a subsequent the conducting part and the non-conducting part are joined. Welding together both parts preferably does this joining. According to the invention friction welding or ultra sonic welding does this

For the methods according to the invention described above, the polymer component in the conductive composite material is compatible with the polymer used in the area around the active area; preferably the same polymer is used. Two polymers are compatible if they adhere well to each other. Use of the same polymer improves adhesion between the active area, the flow field, and the material surrounding it. The flow field is mode of electrical conductive material, the edges around the active area are preferably non conductive to electric current. De polymer used in the preferably non-conducting edges can be a non-filled polymer or a filled polymer, like a fiber reinforced injection-molding compound. Use a filled polymers, like fiber-reinforced polymers in the preferably non-conductive edges, have the advantage of better-matched coefficient of thermal expansion to the conductive composite. According to the invention it is also possible to use other additives in the polymer edge. Examples of such additives are, but not limited to, foaming agents, to reduce cost, and reduce the E-modulus. Also elastomers, preferably thermoplastic elastomers, can be used for the non-conducting edge. This group of polymers has the advantage of better sealing properties, compared to non-elastomer polymers. According to this invention it is also feasible to use more than one polymer in the cell plate edge, for example multi component injection molding can be used, where one of the polymers is for example elastomer, wile the other polymer is a non elastomer thermoplastic.

Application of the method according to the invention is not limited to fuel cell plates, but can be used also the production of cool plates for fuel cells. For manufacturing these cool plates a preheated conductive composite intermediate, a so-called preheated preform, is inserted into a compression mold, or an injection mold. The mold is closed, thus forming a plate with cooling channels. In a next process step the plate is provided with a preferably non-conductive edge. If the plate is molded in an injection mold, the non-conducting edge can be molded in the same cycle. An example of such a plate is illustrated in drawing 7 and 8.

Half cell plates (mono polar plates) manufactured according to one of the methods described above, can be used in Solid Polymer Fuel cell stacks as a low coast alternative to machined graphite plates. Advantages over these machined plates are lower cost price, and a safe isolating edge. Many essential functions in the fuel cell stack like, mounting holes, gas distribution channels, water distribution channels, O-ring groves, O-rings, cooling channels, reaction water removal channels, can all be integrated in the injection molded edge.

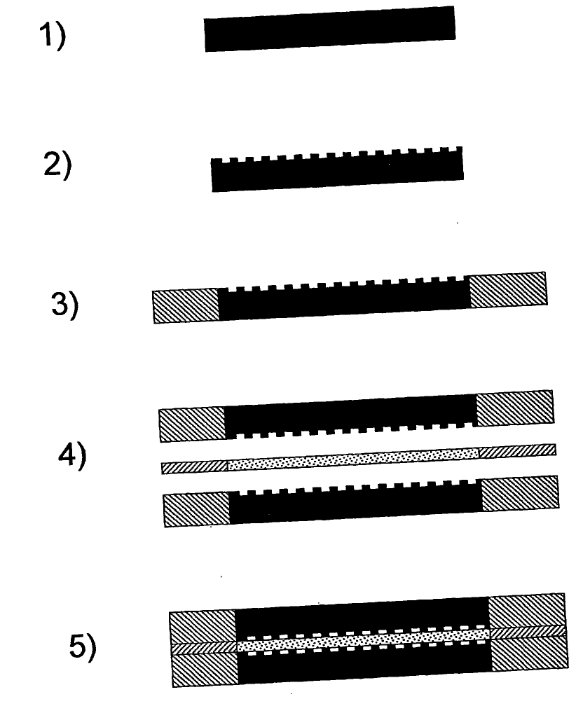

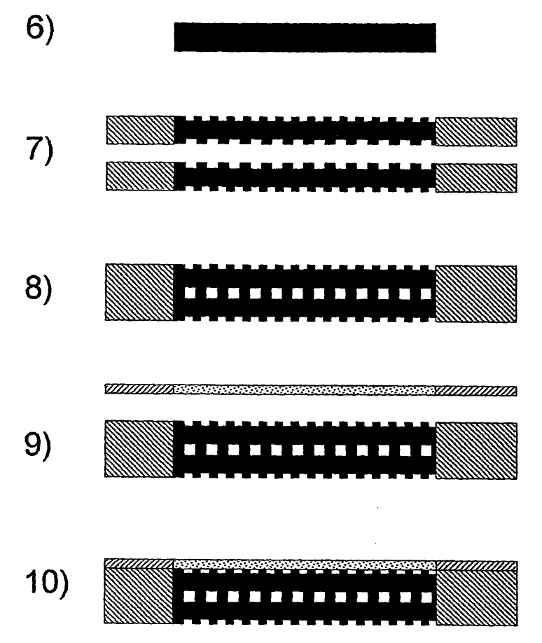

The advantages of the cell plates according to the invention will be ven larger if the cell plate edge and the MEA edge can be welded to for a gastight construction, or if half cell plates or half cool plates can be welded to form a leak free construction. Welding the cell plate edge, to the MEA edge out side the activ area is possible if for both edges compatible polymers, preferably the sam polymers are used. By this method it is possible to weld a cell plate and a MEA in less than one second by for example ultra sonic welding. This welding method performs well for the outer seals of the cells, but does as such not solve the internal sealing of the cell in the are between the gas headers that extend trough the stack, and the gas distribution channels or manifolds ion the individual cells. According to the invention this is solved by a special welding method, using welding tools that weld the MEA-edge inside the gas headers onto the cell plate or cell plate edge. The cell plates used for this welding method have gas header holes with different size. The larger gas header holes allow for the welding tool to weld the MEA-edge around the smaller gas header hole. The welding method according to the invention is illustrated in FIGS. 4 and 5.

The cell plates according to the invention can receive a surface treatment to modify surface properties like wetting behavior or for example contact resistance. The surfaces in the active area and the manifolds can be modified to obtain a hydrophilic or hydrophobic surface. Surface treatment like corona with or without the use of special gas compositions, can be applied to the conductive flow fields to decrease the surface resistance of the flow field in the areas that make contact with the electrode and/or backing. The plates, or a selected part of the plate can be treated with plasma, like for example a fluor-carbon monomer containing plasma to make these surfaces hydrophobic or depending on the gas composition hydrophilic. Hydrophobic channels are needed if the (reaction) water that has to be removed from the fuel cell is removed as small droplets.

Besides application in fuel cells, the invention can also be applied in other electrochemical cells like electrolyzers,

### EXAMPLE 1

A plate like composite material containing a polymer binder, and conductive fillers is is pre heated in a hot air circulation oven to a temperature of 250° C. (see drawing 1) This preheated preform plate is inserted into the mold of a injection molding machine with horizontal mold separation. The mold temperature is kept at 125° C. After insertion of the heated preform the mold is closed and the flow field of a fuel cell is formed in the cavity of the mold (see drawing 2). At the same tim molten polymer is injected into the remaining mold cavity. This polymer melt will cover the edges of the molded flow field, and adhere to it (drawing 3). The polymer solidifies in the mold because the mold temperature is below the melting point or Tg of the polymer used. After sufficient solidification the mold is opened and the plate is ejected from the mold. A MEA comprising a proton conducting membrane, two electrodes, two gas diffusion layers and a non-proton conducting polymer edge are placed between two cell plates manufactured according the method in this example (see drawing 4). The plates and MEA are pressed together and joined by ultra sonic welding (see drawing 5).

### Example 2

A plate like composite material containing a polymer binder, and conductive fillers is pre heated in a hot air circulation oven to a temperature above the melting point of the polymer binder. In this example the plate is heated to 250° C. (see drawing 1). This preheated preform plate is inserted into the mold of a injection molding machine with horizontal mold separation. The mold temperature is kept at 125° C. After insertion of the heated preform the mold is closed and the flow field of a fuel cell is formed in the cavity of the mold (see drawing 7). At the same time molten polymer is injected into the remaining mold cavity. This polymer melt will cover the edges of the molded flow field, and adhere to it (drawing 7). The polymer solidifies in the mold because the mold temperature is below the melting point or Tg of the polymer used. After sufficient solidification the mold is opened and the plate is ejected from the mold. Two of these plates are joined by thermal welding (drawing 8). A MEA comprising a proton conducting membrane, two electrodes, two gas diffusion layers and a non-proton conducting polymer edge is placed between on top of the welded bipolar plate manufactured according the method in this example (see drawing 9). The plates and MEA are pressed together and joined by ultra sonic welding (see drawing 10).

1. A polymer electrolyte fuel cell comprising a proton conducting membrane, electrodes containing a catalyst on both sides, and one or two cell plates characterized in that the cell plate has a electric conductive part and a electric non conductive part, and that this non conductive part forms a edge around the conductive part.

2. A product according to claim 1, characterized in that the conductive part is made of conductive polymer containing composite material, and the edge is made of non conductive polymer material, and both polymers are compatible.

3. A product according to any of the preceding claims, characterized in that the gas channels in the conducting part of the cell plate, and the gas manifolds in the non-conducting part are both hydrophobic.

4. A product according to any of the preceding claims, characterized in that the gas channels in the conducting part of the cell plate, and the gas manifolds in the non-conducting part are both hydrophilic.

5. A product according to any of the preceding claims, characterized in that the polymer binder in the conducting part, and the polymer in the non-conducting part are of the same type.

6. A product according to any of the preceding claims, characterized in that the MEA has a polymer edge, and that this polymer edge is made of the same polymer that is used in the cell plate edges.

7. A product according to any of the preceding claims, characterized in that the MEA and the cell plate are welded together.

8. A method for the production of cell plates for polymer electrolyte fuel cells comprising the steps of; compression molding a flow field from a conductive composite preform, insertion of this compression molded flow field into a injection molding machine, injecting a polymer edge around the inserted flow field.

9. A method for the production of cell plates for polymer electrolyte fuel cells comprising the steps of; insertion of a preheated preform of conductive composite material into a injection molding machine, molding this preform in the injection mold and injecting a polymer edge around conductive composite flow field.

10. A method for the production of cell plates for polymer electrolyte fuel cells according to any of the preceding claims, characterized in that the composite intermediate contains a polymer binder, conductive fillers and fibers like glass fibers, aramid fibers, carbon fibers or graphite fibers.

11. A method for the production of cell plates for polymer electrolyte fuel cells according to any of the preceding claims, characterized in that the intermediate product is porous, and that this porosity is between 0% en 90%.

12. A method for the production of cell plates for polymer electrolyte fuel cells according to any of the preceding claims, characterized in that the intermediate product is porous, and that this porosity is between 0% en 90%, and the molded plate has a porosity that is less than that of the intermediate.
